(19) United States
(12) Patent Application Publication
(10) Pub. No.: US 2026/0264998 A1
(43) Pub. Date: Sep. 10, 2026

(54) OBJECT TRANSPORTING METHOD AND CUBE STORAGE SYSTEM

(71) Applicant: TAC Dynamics Inc., New Taipei City (TW)

(72) Inventors: Zhenyu Song, New Taipei City (TW); Chuan Kai Lin, New Taipei City (TW); Hsuan Po Chen, New Taipei City (TW)

(73) Assignee: TAC Dynamics Inc., New Taipei City (TW)

(21) Appl. No.: 19/075,719

(22) Filed: Mar. 10, 2025

(51) Int. Cl. B65G 43/02; B65G 1/04; B65G 1/137

(52) U.S. Cl. CPC B65G 43/02; B65G 1/0478; B65G 1/0485; B65G 1/0492; B65G 1/1373; B65G 2203/0283

(57) ABSTRACT

Provided are an object transporting method and a cube storage system. The method includes: in response to a transport task for a target object stored in a vertical storage structure, determining whether there is a blocking object relative to the target object stored in the vertical storage structure, in which the transport task indicates to transport the target object from a current position to a target position; in response to determining that there is the blocking object relative to the target object stored in the vertical storage structure, controlling an assisting transport robot to remove the blocking object from the vertical storage structure; in response to determining that there is no blocking object relative to the target object stored in the vertical storage structure, controlling a first transport robot to move to the current position to transport the target object to the target position.

### BACKGROUND

### Technical Field

The disclosure relates to a warehouse management mechanism, and in particular to an object transporting method and a cube storage system.

### Description of Related Art

The rapid development of e-commerce has been accelerated during the epidemic period, driving the rise of B2C (business to consumer) logistics. In the post-epidemic era, people are increasingly relying on e-commerce for shopping. However, in view of the increasingly serious problem of labor shortage, the phenomenon has led to the vigorous development of smart logistics.

In order to improve transportation efficiency, many logistics and warehousing companies have begun to integrate software and hardware and come up with new solutions to simultaneously solve the problems of numerous e-commerce products, fast delivery, and difficulty in obtaining storage space.

### SUMMARY

In view of the above, the disclosure provides an object transporting method and a cube storage system, which can be used to solve the above technical problems.

An embodiment of the disclosure provides an object transporting method, suitable for a control system. The method includes: in response to a first transport task for a first target object stored in a first vertical storage structure, determining whether there is at least one blocking object relative to the first target object stored in the first vertical storage structure, in which the first transport task indicates to transport the first target object from a current position to a first target position, the first vertical storage structure includes multiple first object storage spaces arranged vertically, and the current position of the first target object corresponds to one of the multiple first object storage spaces; in response to determining that there is the at least one blocking object relative to the first target object stored in the first vertical storage structure, controlling at least one assisting transport robot to remove the at least one blocking object from the first vertical storage structure; in response to determining that there is no blocking object relative to the first target object stored in the first vertical storage structure, controlling a first transport robot to move to the current position to transport the first target object to the first target position.

An embodiment of the disclosure provides a cube storage system, including a cube storage structure and a control system. The cube storage structure includes a first vertical storage structure, and the first vertical storage structure includes multiple first object storage spaces arranged vertically. The control system is configured to: in response to a first transport task for a first target object stored in the first vertical storage structure, determine whether there is at least one blocking object relative to the first target object stored in the first vertical storage structure, in which the first transport task indicates to transport the first target object from a current position to a first target position, and the current position of the first target object corresponds to one of the multiple first object storage spaces; in response to determining that there is the at least one blocking object relative to the first target object stored in the first vertical storage structure, control at least one assisting transport robot to remove the at least one blocking object from the first vertical storage structure; in response to determining that there is no blocking object relative to the first target object stored in the first vertical storage structure, control a first transport robot to move to the current position to transport the first target object to the first target position.

### BRIEF DESCRIPTION OF THE DRAWINGS

FIG. 1 is a schematic diagram of a cube storage system according to an embodiment of the disclosure.

FIG. 2 is a schematic diagram of transporting an object according to an embodiment of the disclosure.

FIG. 3 is a flow chart of an object transporting method according to an embodiment of the disclosure.

FIG. 4 is an application scenario diagram according to an embodiment of the disclosure.

FIG. 5 is a flowchart of performing a sorting task according to an embodiment of the disclosure.

FIG. 6 is a flow chart of a return process according to FIG. 5.

FIG. 7 is a flow chart of performing a loading task according to the seventh embodiment of the disclosure.

### DESCRIPTION OF THE EMBODIMENTS

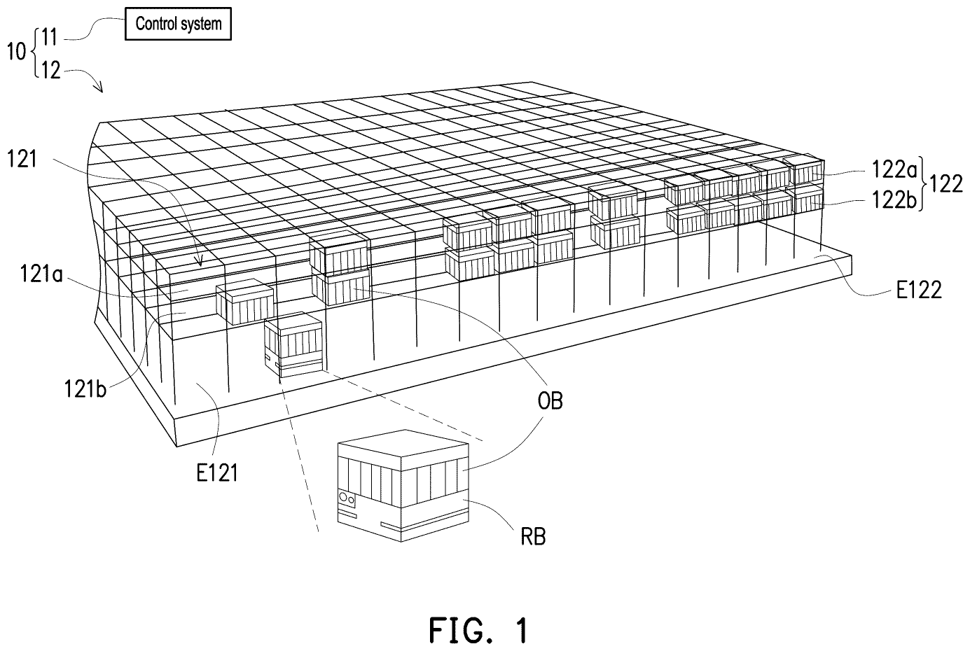

Please refer to FIG. 1, which is a schematic diagram of a cube storage system according to an embodiment of the disclosure. In FIG. 1, a cube storage system 10 includes a control system 11 and a cube storage structure 12.

In different embodiments, the control system 11 may be implemented as, for example, various smart devices and/or computer devices, but the disclosure is not limited thereto. In some embodiments, the control system 11 may include a storage circuit and a processor, in which the storage circuit is, for example, any type of fixed or removable random access memory (RAM), read-only memory (ROM), flash memory, hard disk, or other similar devices, or a combination of the devices, and may be used to record multiple program codes or modules.

In addition, the processor is coupled to the storage circuit, and may be, for example, a general-purpose processor, a special-purpose processor, a conventional processor, a digital signal processor, multiple microprocessors, one or more microprocessors combined with digital signal processor cores, a controller, a microcontroller, an application specific integrated circuit (ASIC), a field programmable gate array (FPGA), any other types integrated circuits, a state machine, an advanced RISC machine (ARM)-based processor, and the like.

In an embodiment of the disclosure, the processor of the control system 11 may implement various operations mentioned in the following embodiments by accessing the modules/program codes in the storage circuit. In some embodiments, the control system 11 may further include multiple subsystems (for example, a micro warehouse center, a warehouse management system, a warehouse control system, a warehouse execution system, a material handling system, and a vehicle dispatching system), and the subsystems may communicate and coordinate with each other to achieve the various operations mentioned below, but the disclosure is not limited thereto.

In an embodiment of the disclosure, the cube storage structure 12 may include multiple vertical storage structures (for example, vertical storage structures 121, 122), and each vertical storage structure may include multiple object storage spaces. As an example, the vertical storage structure 121 may include two object storage spaces 121a and 121b, in which the object storage spaces 121a and 121b are, for example, arranged in the vertical storage structure 121 sequentially from top to bottom. As another example, the vertical storage structure 122 may include two object storage spaces 122a and 122b, in which the object storage spaces 122a and 122b are, for example, arranged in the vertical storage structure 122 sequentially from top to bottom.

In FIG. 1, each object storage space may be used to store an object OB, in which each object OB is, for example, an item storage object (such as a box) that may be used to store an item. In other embodiments, each object OB may also be implemented as other types of item storage objects according to the needs of the designer, such as pallets, but the disclosure is not limited thereto.

In an embodiment of the disclosure, each object storage space and object OB may be provided with corresponding engaging mechanisms (such as latches, but the disclosure is not limited thereto), so that each object OB may be securely stored in the corresponding object storage space.

In an embodiment of the disclosure, the control system 11 may arrange/control a transport robot RB (which is, for example, an automated guided vehicle, AGV) to move and transport the required object OB in the cube storage structure 12. In an embodiment, for an object OB that has been stored in a certain object storage space, the control system 11 may control the transport robot RB to move to the corresponding vertical storage structure, and the transport robot RB may vertically ascend and descend in the vertical storage structure to access and transport the required OB. In various embodiments, the transport robot RB may be designed with a climbing mechanism that may be used to vertically ascend and descend in the vertical storage structure, but the disclosure is not limited thereto.

For example, for an object OB that has been stored in the object storage space 122b, the control system 11 may arrange the transport robot RB to move to an entry-exit point E122 (for example, at the bottom of the vertical storage structure 122, or may be understood as the ground corresponding to the location of the vertical storage structure 122) of the corresponding vertical storage structure 122. After the transport robot RB arrives at the entry-exit point E122, the transport robot RB may vertically ascend in the vertical storage structure 122 to a position below the object storage space 122b. Then, the transport robot RB may release the engaging mechanism between the object storage space 122b and the object OB, and then allow the object OB to be carried on the transport robot RB.

Afterward, the transport robot RB carrying the object OB may vertically descend in the vertical storage structure 122 to the entry-exit point E122 (for example, the ground), and may transport the carried object OB to a required target position according to the instruction of the control system 11.

In the first embodiment, assuming that the target position is the object storage space 121a in the vertical storage structure 121, then the transport robot RB at the entry-exit point E122 may move to an entry-exit point E121 (for example, at the bottom of the vertical storage structure 121) corresponding to the vertical storage structure 121, and may vertically ascend in the vertical storage structure 121 after arriving at the entry-exit point E121, until the carried object OB enters the object storage space 121a. Afterward, the transport robot RB may trigger the engaging mechanism between the object storage space 121a and the object OB, so that the object OB may be stored in the object storage space 121a, but the disclosure is not limited thereto.

In the second embodiment, assuming that the target position is an outbound point of the cube storage structure 12, then the transport robot RB at the entry-exit point E122 may move to the outbound point to transport the carried object OB to the outbound point, but the disclosure is not limited thereto.

In an embodiment, if the object OB carried on the transport robot RB is determined to be a blocking object that blocks other objects, then the control system 11 may arrange the transport robot RB to transport the object OB to other object storage spaces in the cube storage structure 12 in the manner described in the first embodiment.

For example, if the control system 11 needs to retrieve an object OB (hereinafter referred to as the target object) stored in the object storage space 122a in response to a certain task, then the objects OB stored in the object storage space 122b as shown in FIG. 1 may be understood as blocking objects relative to the target object due to blocking the path of the transport robot RB to directly access the target object.

In this case, the control system 11 may arrange one or more transport robots RB to move the objects OB stored in the object storage space 122b to other object storage spaces in the cube storage structure 12 for storage according to the foregoing teachings, and the control system 11 may record the other object storage spaces accordingly, so that the objects OB may be accessed when needed, but the disclosure is not limited thereto.

In another embodiment, if an object OB carried on the transport robot RB is an object that the relevant personnel want to retrieve, then the control system 11 may arrange the transport robot RB to transport the object OB to the outbound point of the cube storage structure 12 in the manner described in the second embodiment, but the disclosure is not limited thereto.

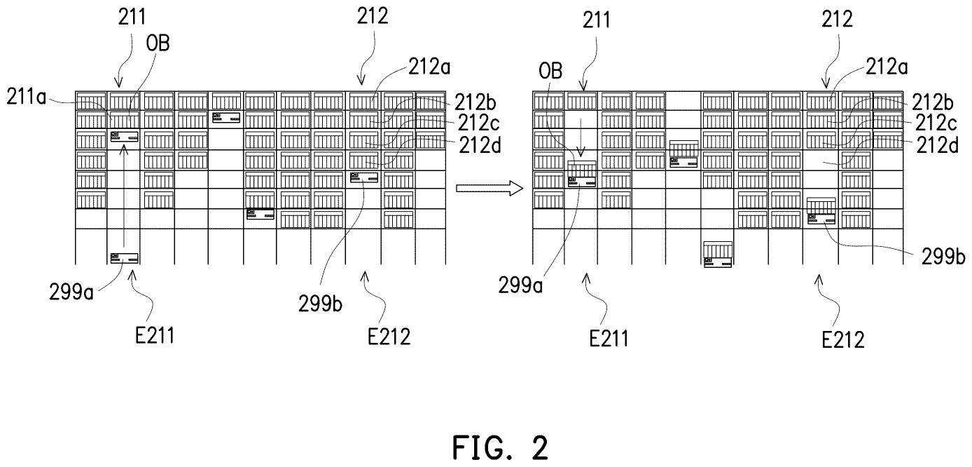

Please refer to FIG. 2, which is a schematic diagram of transporting an object according to an embodiment of the disclosure.

In FIG. 2, it is assumed that the cube storage structure 12 under consideration has the configuration (that is, each vertical storage structure includes 7 object storage spaces) shown in the drawing. In this embodiment, assuming that a transport robot 299a is arranged to transport an object OB in an object storage space 211a to the corresponding target position, then the transport robot 299a may, after arriving at the entry-exit point E211 (for example, at the bottom/ground of a vertical storage structure 211) of the vertical storage structure 211 to which the object storage space 211a belongs, vertically ascend in the vertical storage structure 211 to a position below the object storage space 211a. Then, the transport robot 299a may release the engaging mechanism between the object storage space 211a and the object OB, so that the object OB is carried on the transport robot 299a.

Afterward, the transport robot 299a carrying the object OB may vertically descend in the vertical storage structure 211 to the entry-exit point E211, and transport the object OB to the corresponding target position.

In addition, assuming that the control system 11 needs to retrieve the target object in an object storage space 212a in response to a certain task, then the control system 11 may regard all objects OB between the entry-exit point E212 of a corresponding vertical storage structure 212 and the target object as the blocking objects (that is, the objects OB in the object storage spaces 212b to 212d). In this case, the control system 11 may arrange one or more transport robots (such as a transport robot 299b) to transport the objects OB in the object storage spaces 212b to 212d to other object storage spaces in the cube storage structure 12. In an embodiment of the disclosure, the transport robot used to transport the blocking objects may be referred to as an assisting transport robot, but the disclosure is not limited thereto.

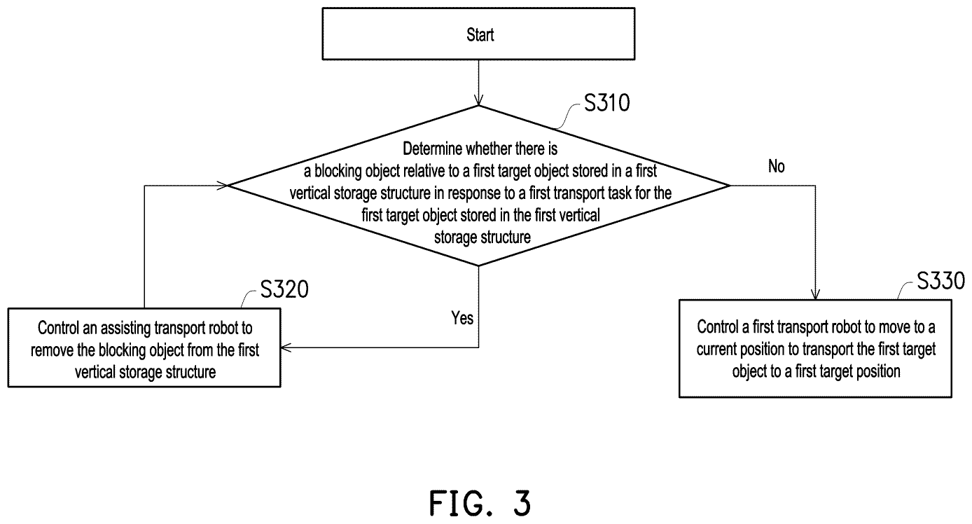

Please refer to FIG. 3, which is a flow chart of an object transporting method according to an embodiment of the disclosure. The method in this embodiment may be performed by the control system 11 in FIG. 1. The details of each step in FIG. 3 will be described below with reference to the components shown in FIG. 1.

First, in Step S310, in response to a first transport task for a first target object stored in a first vertical storage structure, the control system 11 determines whether there is a blocking object relative to the first target object stored in the first vertical storage structure, in which the first transport task indicates to transport the first target object from a current position to a first target position. Also, the first vertical storage structure includes multiple first object storage spaces arranged vertically, and the current position of the first target object corresponds to one of the first object storage spaces.

In an embodiment, the first vertical storage structure is, for example, one of the multiple vertical storage structures of the cube storage structure 12, but the disclosure is not limited thereto.

In an embodiment, the control system 11 may determine whether there is at least one object stored in the first object storage space between the current position of the first target object and a first entry-exit point of the first vertical storage structure.

In response to determining that there is the at least one object stored in the first object storage space between the current position of the first target object and the first entry-exit point, the control system 11 may determine the at least one object as at least one blocking object relative to the first target object. On the other hand, in response to determining that there is no object stored in the first object storage space between the current position of the first target object and the first entry-exit point, the control system 11 may determine that there is no blocking object relative to the first target object stored in the first vertical storage structure.

In the third embodiment, assuming that the first target object is the object OB stored in the object storage space 211a in FIG. 2, then the corresponding first vertical storage structure is, for example, the vertical storage structure 211. Next, the control system 11 may determine whether there is at least one object stored in the object storage space between the current position (that is, the object storage space 211a) of the first target object and the entry-exit point E211 of the vertical storage structure 211.

As may be seen from FIG. 2, since there is no object stored in the object storage space between the entry-exit point E211 and the object storage space 211a, the control system 11 may determine that there is no blocking object relative to the first target object stored in the first vertical storage structure.

In the fourth embodiment, assuming that the first target object is an object OB stored in the object storage space 212a in FIG. 2, then the corresponding first vertical storage structure is, for example, a vertical storage structure 212. Then, the control system 11 may determine whether there is at least one object stored in the object storage space between the current position (that is, the object storage space 212a) of the first target object and the entry-exit point E212 of the vertical storage structure 212.

As may be seen from FIG. 2, since there are other objects OB stored in the object storage spaces 212b to 212d between the entry-exit point E212 and the object storage space 212a, the control system 11 may determine the objects OB stored in the object storage spaces 212b to 212d as the blocking objects relative to the first target object, but the disclosure is not limited thereto.

In an embodiment, in response to determining that there is no blocking object relative to the first target object stored in the first vertical storage structure, the control system 11 may proceed to Step S330 after Step S310.

On the other hand, in response to determining that there is the blocking object relative to the first target object stored in the first vertical storage structure, the control system 11 may proceed to Step S320 after Step S310 to control the assisting transport robot to remove the blocking object from the first vertical storage structure. For example, if the first target object is the object OB stored in the object storage space 212a, then the control system 11 may arrange the assisting transport robot to remove the objects OB stored in the object storage spaces 212b to 212d from the vertical storage structure 212.

In an embodiment, during the execution of Step S320, the control system 11 may perform the following steps in sequence: (a) finding a specific blocking object closest to the first entry-exit point among the at least one blocking object; (b) controlling a transport robot as one of at least one assisting transport robot to move to the first entry-exit point (which is, for example, at the bottom of the first vertical storage structure), and controlling the transport robot to vertically ascend in the first vertical storage structure to access the specific blocking object; (c) controlling the transport robot to move the specific blocking object to a second object storage space of the cube storage structure 12, in which the second object storage space belongs to a second vertical storage structure of the cube storage structure 12; (d) repeating Steps (a) to (c) until there is no blocking object relative to the first target object stored in the first vertical storage structure.

During the execution of Step (c), the control system 11 may perform: controlling the transport robot to vertically descend in the first vertical storage structure to the first entry-exit point of the first vertical storage structure; controlling the transport robot to move from the first entry-exit point of the first vertical storage structure to the second entry-exit point of the second vertical storage structure; and controlling the transport robot to vertically ascend in the second vertical storage structure to the second object storage space, and securing the specific blocking object in the second object storage space.

In an embodiment, before controlling the transport robot to move from the first entry-exit point of the first vertical storage structure to the second entry-exit point of the second vertical storage structure, the control system 11 may further determine whether the second vertical storage structure is locked. In response to determining that the second vertical storage structure is not locked, the control system 11 may lock the second vertical storage structure, and control the transport robot to move from the first entry-exit point of the first vertical storage structure to the second entry-exit point of the second vertical storage structure. On the other hand, in response to determining that the second vertical storage structure is locked, the control system 11 may control the transport robot to move from the first entry-exit point of the first vertical storage structure to the second entry-exit point of the second vertical storage structure.

Based on the above, in the fourth embodiment, the control system 11 may first determine that the object OB stored in the object storage space 212d is the specific blocking object, and arrange the transport robot 299b to move to the entry-exit point E212 as the assisting transport robot, and control the transport robot 299b to ascend in the vertical storage structure 212 to access the object OB stored in the object storage space 212d.

Afterward, the control system 11 may control the transport robot 299b to vertically descend in the vertical storage structure 212 to the entry-exit point E212, and determine whether the second vertical storage structure is locked. If no, then after locking the second vertical storage structure, the control system 11 may control the transport robot 299b to move from the entry-exit point E212 to the second entry-exit point of the second vertical storage structure; if yes, then the control system 11 may directly control the transport robot 299b to move from the entry-exit point E212 to the second entry-exit point of the second vertical storage structure, but the disclosure is not limited thereto. Next, the control system 11 may control the transport robot 299b to vertically ascend in the second vertical storage structure to the second object storage space, and secure the specific blocking object to the second object storage space.

The foregoing concepts may be used again to move the objects OB stored in the object storage spaces 212c and 212b to other object storage spaces in the cube storage structure 12, so details will not be repeated here.

After Step S320 is completed, the control system 11 may perform Step S310 again. At this time, since there is no blocking object relative to the first target object, the control system 11 may proceed to Step S330. In another embodiment, after Step S320 is completed, the control system 11 may also directly perform Step S330, but the disclosure is not limited thereto.

In Step S330, the control system 11 controls the first transport robot to move to the current position to transport the first target object to the first target position.

During the execution of Step S330, the control system 11 may control the first transport robot to move to the first entry-exit point, and control the first transport robot to vertically ascend in the first vertical storage structure to the current position of a target object to access the first target object.

Afterward, the control system 11 may control the first transport robot to move the first target object from the current position to the first target position. For example, the control system 11 may control the first transport robot to vertically descend from the current position of the first target object to the first entry-exit point of the first vertical storage structure, and control the first transport robot to move from the first entry-exit point of the first vertical storage structure to the first target position (for example, the outbound point of the cube storage structure 12).

In an embodiment of the disclosure, the first transport task may be a sorting task or an inventory task.

In the fifth embodiment, when the control system 11 determines that a certain order (for example, an e-commerce shopping order) needs to obtain one or more of item stored in the first target object, then the control system 11 may accordingly determine a sorting task as the first transport task, and accordingly set the first target position corresponding to the first transport task as the outbound point of the cube storage structure 12. Based on the above, the control system 11 may accordingly perform the operations in the foregoing embodiments to arrange the first transport robot to transport the first target object to the outbound point of the cube storage structure 12 to facilitate subsequent sorting.

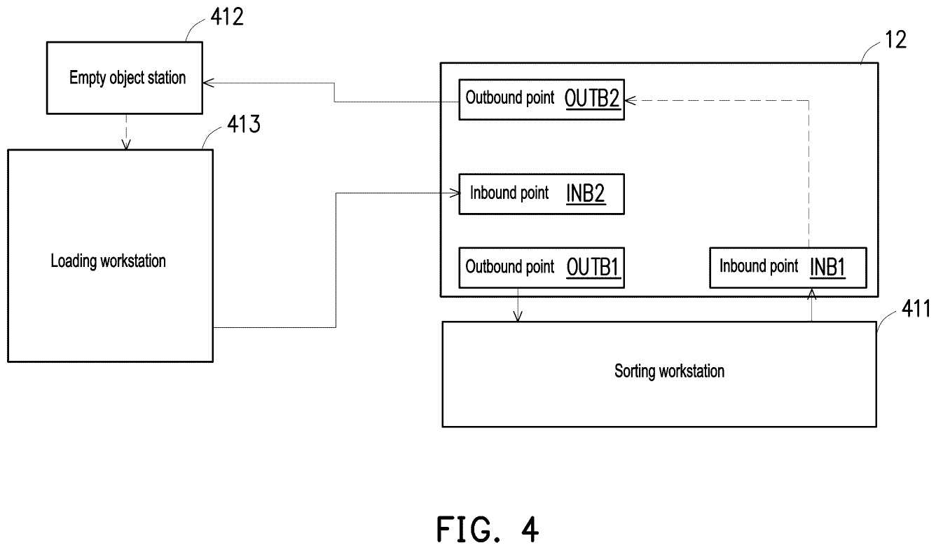

For ease of understanding, the following embodiments will be further described with reference to the scenario shown in FIG. 4, and FIG. 4 is an application scenario diagram according to an embodiment of the disclosure.

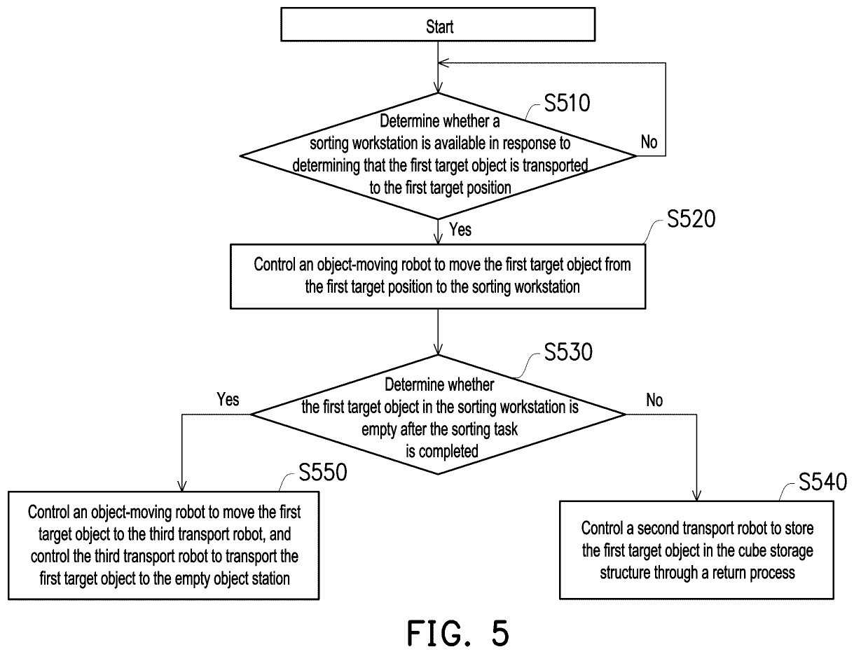

In FIG. 4, the control system 11 may arrange the first transport robot to transport the first target object to an outbound point OUTB1 of the cube storage structure 12 in response to the sorting task. Afterward, the control system 11 may accordingly perform the method shown in FIG. 5.

Please refer to FIG. 5, which is a flow chart of performing the sorting task according to an embodiment of the disclosure.

In Step S510, in response to determining that the first target object is transported to the first target position (for example, the outbound point OUTB1 of the cube storage structure 12), the control system 11 determines whether a sorting workstation 411 is available. In an embodiment, if the sorting workstation 411 has space to place the first target object, then the control system 11 may determine that the sorting workstation 411 is available. Conversely, if no space is available, then it may be determined that the sorting workstation 411 is unavailable, but the disclosure is not limited thereto.

In an embodiment, the sorting workstation 411 may be used to allow the relevant personnel and/or robotic arms to sort (for example, load into logistics containers) or inventory the item in the order in response to the order, but the disclosure is not limited thereto.

In an embodiment, in response to determining that the sorting workstation 411 is unavailable, then the control system 11 may repeat the execution of Step S510 until the sorting workstation 411 is determined to be available, but the disclosure is not limited thereto.

In an embodiment, in response to determining that the sorting workstation 411 is available, the control system 11 may control an object-moving robot (for example, a robotic arm) to move the first target object carried by the first transport robot from the first target position (for example, the outbound point OUTB1 of the cube storage structure 12) to the sorting workstation 411, to facilitate the relevant personnel and/or robotic arms to perform the required sorting.

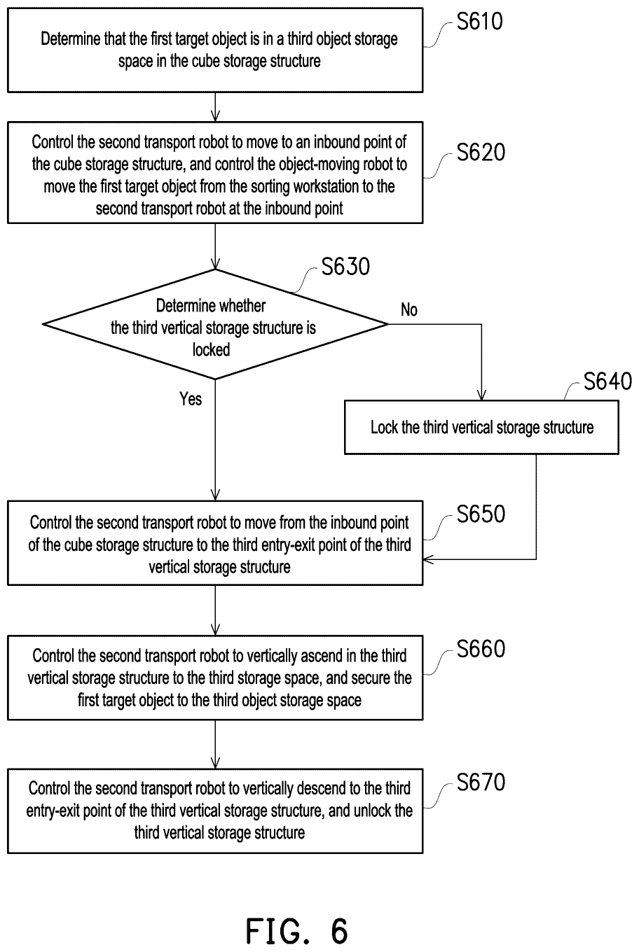

Next, in Step S530, after the sorting task of the first target object is completed, the control system 11 may determine whether the first target object in the sorting workstation 411 is empty (that is, determine whether the items in the first target object are all removed from the first target object). If no, then this means that there are still item in the first target object, the control system 11 may proceed to Step S540 to control the second transport robot to store the first target object in the cube storage structure 12 through a return process, in which the return process will be explained separately with FIG. 6.

On the other hand, if the first target object of the sorting workstation 411 is empty, then this means that there is no item stored in the first target object, that is, the first target object may again be used to load other items. In this case, the control system 11 may proceed to Step S550 to control the object-moving robot to move the first target object to a third transport robot, and control the third transport robot to transport the first target object to an empty object station 412.

During the execution of Step S550, the control system 11 may, for example, arrange the third transport robot to an inbound point INB1 of the cube storage structure 12, and control the object-moving robot to move the first target object in the sorting workstation 411 to the third transport robot. Afterward, the third transport robot carrying the first target object may move to an outbound point OUTB2 of the cube storage structure 12, and the first target object may be moved to the empty object station 412 by the relevant personnel and/or robotic arms.

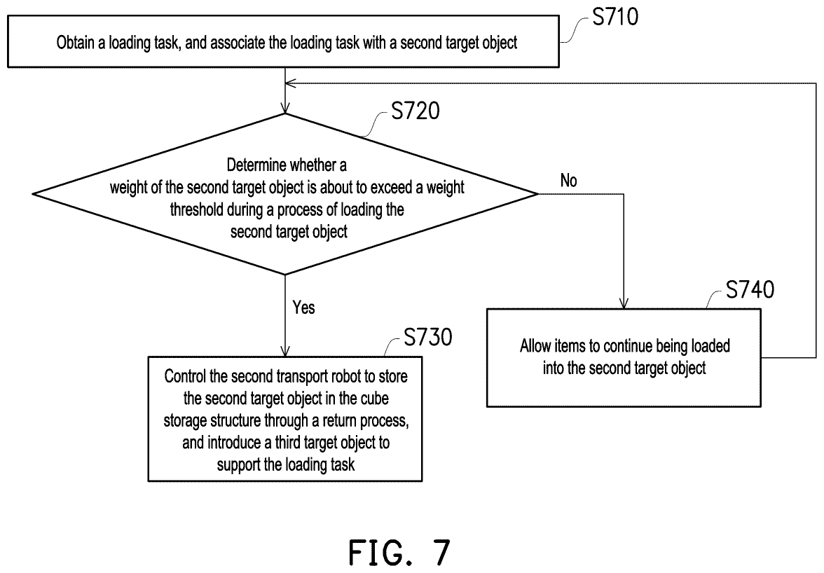

In an embodiment of the disclosure, the empty object station 412 may store multiple empty objects that do not contain any item, the empty objects may be loaded with corresponding items by the relevant personnel and/or robotic arms in response to a corresponding loading task, and then transported by the corresponding transport robot to an object storage space in the cube storage structure 12 for storage, but the disclosure is not limited thereto. The content related to the loading task will be explained later with FIG. 7.

Please refer to FIG. 6, which is a flow chart of a return process according to FIG. 5. First, in Step S610, the control system 11 determines that the first target object is in a third object storage space in the cube storage structure 12, in which the third object storage space belongs to a third vertical storage structure in the cube storage structure 12, and there is a third entry-exit point at the bottom of the third vertical storage structure. In different embodiments, the third vertical storage structure may be the same as or different from the first and second vertical storage structures, but the disclosure is not limited thereto.

Afterward, in Step S620, the control system 11 controls the second transport robot to move to the inbound point INB1 of the cube storage structure 12, and control the object-moving robot to move the (not empty) first target object from the sorting workstation 411 to the second transport robot at the inbound point INB1.

In Step S630, the control system 11 determines whether the third vertical storage structure is locked. If no, then the control system 11 may perform Step S640 to lock the third vertical storage structure and proceed to Step S650; if yes, then the control system 11 may directly perform Step S650, but the disclosure is not limited thereto.

In Step S650, the control system 11 controls the second transport robot to move from the inbound point INB1 of the cube storage structure 12 to the third entry-exit point of the third vertical storage structure.

In Step S660, the control system 11 controls the second transport robot to vertically ascend in the third vertical storage structure to the third object storage space, and secure the first target object in the third object storage space.

In Step S670, the control system 11 controls the second transport robot to vertically descend to the third entry-exit point of the third vertical storage structure, and unlocks the third vertical storage structure.

In the sixth embodiment, when the control system 11 determines for some reasons that it is necessary to confirm whether the number of items stored in the first target object is correct, then the control system 11 may accordingly determine an inventory task as the first transport task, and accordingly set the first target position corresponding to the first transport task as the outbound point of the cube storage structure 12. Based on the above, the control system 11 may accordingly perform the operations in the foregoing embodiments to arrange the first transport robot to transport the first target object to the outbound point of the cube storage structure 12 to facilitate subsequent inventory.

In the sixth embodiment, the control system 11 may also perform Steps S510 to S520 to move the first target object to the sorting workstation 411 to facilitate the relevant personnel to confirm the number of items in the first target object.

In response to determining that the items in the first target object are correct through inventory, the control system 11 may accordingly perform Step S540 to control the second transport robot to store the first target object in the cube storage structure through the return process. For relevant details, reference may be made to the descriptions in the forgoing embodiments, so details will not be repeated here.

On the other hand, in response to determining that the items in the first target object are incorrect through inventory, the relevant personnel may input the correct quantity of the items, and then the control system 11 accordingly performs Step S540, but the disclosure is not limited thereto.

Please refer to FIG. 7, which is a flow chart of performing the loading task according to the seventh embodiment of the disclosure. In the seventh embodiment, the relevant personnel and/or robotic arms may retrieve an empty object from the empty object station 412 at a loading workstation 413 in response to a certain loading task, and the empty object (hereinafter referred to as a second target object) is loaded.

Based on the above, in Step S710, the control system 11 may obtain the loading task, and associate the loading task with the second target object. In an embodiment, the body of the second target object may be provided with, for example, an indicator (such as a barcode and/or QR code) corresponding to the identity of the second target object, and the relevant personnel may read the indicator through a corresponding reader when processing the loading task, and then associate the loading task with the second target object, but the disclosure is not limited thereto.

Afterward, the relevant personnel may load the corresponding item into the second target object according to the loading task. For example, assuming that the loading task indicates to load 10 dolls into the second target object, then the relevant personnel and/or robotic arms may accordingly load 10 dolls into the second target object, but the disclosure is not limited thereto.

Next, in Step S720, during the process of the items being loaded into the second target object, the control system 11 determines whether the weight of the second target object is about to exceed a weight threshold.

If yes (for example, installing one more item causes the weight of the second target object to exceed the weight threshold), then the control system 11 may accordingly perform Step S730, control the second transport robot to store the second target object in the cube storage structure 12 through the return process, and introduce the third target object to support the loading task. On the other hand, in response to determining that the weight of the second target object is not about to exceed the weight threshold, the control system 11 may perform Step S740 to allow items to continue being loaded into the second target object, and return to Step S720, but the disclosure is not limited thereto.

In FIG. 4, during the process of transporting the second target object to the cube storage structure 12, the object-moving robot may first move the second target object at the loading workstation 413 to the second transport robot at the inbound point INB2 of the cube storage structure 12, and then the second transport robot transports the second target object to the corresponding object storage space, but the disclosure is not limited thereto.

For example, in the case that there are 6 dolls stored in the second target object, if the control system 11 determines that adding another doll causes the weight of the second target object to exceed the weight threshold, then the control system 11 may transport the second target object to the cube storage structure 12 for storage through the return process, and then introduce a new empty object (such as the third target object) to store the remaining four dolls, but the disclosure is not limited thereto.

In summary, embodiments of the disclosure provide a technical solution for moving the target object and/or blocking object in the cube storage structure. Since the embodiments of the disclosure allow the transport robot to access and transport objects (such as boxes and/or pallets) in a vertical ascent/descent manner in the cube storage structure, compared with conventional large-scale automated warehousing, the method of the embodiments of the disclosure are highly flexible. In this case, the cube storage structure can be set up closer to the end consumer, which can significantly shorten the pickup time.

Although the disclosure has been disclosed above through embodiments, the embodiments are not intended to limit the disclosure. Persons with ordinary knowledge in the relevant technical field may make some changes and modifications without departing from the spirit and scope of the disclosure. Therefore, the protection scope of the disclosure shall be determined by the appended claims.

What is claimed is:

1. An object transporting method, executed by a cube system comprising a control system and a cube storage structure, wherein the cube storage structure comprises a first vertical storage structure, and the method comprises:
in response to a first transport task for a first target object stored in the first vertical storage structure, determining, by the control system, whether there is a blocking object relative to the first target object stored in the first vertical storage structure, wherein the first transport task indicates to transport the first target object from a current position to a first target position, the first vertical storage structure comprises a plurality of first object storage spaces arranged vertically, and the current position of the first target object corresponds to one of the first object storage spaces;
in response to determining that there is the blocking object relative to the first target object stored in the first vertical storage structure, controlling, by the control system, at least one assisting transport robot to move at a bottom of the cube storage structure to a bottom of the first vertical storage structure, directly climb vertically within a space of the first vertical storage structure from the bottom of the first vertical storage structure to a position below the blocking object, access the blocking object and then vertically descend within the first vertical storage structure to the bottom of the first vertical storage structure to remove the blocking object from the first vertical storage structure;
in response to determining that there is no blocking object relative to the first target object stored in the first vertical storage structure, controlling, by the control system, a first transport robot to move at the bottom of the cube storage structure to the bottom of the first vertical storage structure, climb vertically within the space of the first vertical storage structure from the bottom of the first vertical storage structure to the current position, access the first target object and then vertically descend within the first vertical storage structure to the bottom of the first vertical storage structure to transport the first target object to the first target position.

2. The method as claimed in claim 1, wherein the first vertical storage structure comprises a first entry-exit point at a bottom of the first vertical storage structure, and the method comprises:
in response to determining that there is at least one object stored in the first object storage spaces between the current position of the first target object and the first entry-exit point, each of the at least one object is determined to be the blocking object relative to the first target object.

3. The method as claimed in claim 1, wherein the first vertical storage structure comprises a first entry-exit point at the bottom of the first vertical storage structure, and the method comprises executing following steps by the control system: in response to determining that a plurality of the blocking objects relative to the first target object are stored in the first vertical storage structure, controlling the at least one assisting transport robot to remove the plurality of the blocking objects from the first vertical storage structure comprises:
(a) finding a specific blocking object closest to the first entry-exit point among the plurality of the blocking objects;
(b) controlling a transport robot as one of the at least one assisting transport robot to move at the bottom of the cube storage structure to the first entry-exit point, and controlling the transport robot to vertically ascend, from the first entry-exit point, in the first vertical storage structure to be under the specific blocking object to access the specific blocking object and then vertically descend within the first vertical storage structure to the first entry-exit point to remove the specific blocking object from the first vertical storage structure;
(c) controlling the transport robot to move the specific blocking object to a second object storage space of the cube storage structure, wherein the second object storage space belongs to a second vertical storage structure of the cube storage structure;
(d) repeating (a) to (c) until there is no blocking object relative to the first target object stored in the first vertical storage structure.

4. The method as claimed in claim 3, wherein the second vertical storage structure comprises a second entry-exit point at a bottom of the second vertical storage structure, and step (c) comprises:
controlling the transport robot to move at the bottom of the cube storage structure from the first entry-exit point of the first vertical storage structure to the second entry-exit point of the second vertical storage structure;
controlling the transport robot to vertically ascend, from the second entry-exit point, in the second vertical storage structure to the second object storage space, and securing the specific blocking object to the second object storage space.

5. The method as claimed in claim 4, wherein before controlling the transport robot to move, at the bottom of the cube storage structure, from the first entry-exit point of the first vertical storage structure to the second entry-exit point of the second vertical storage structure, the method further comprises:
determining whether the second vertical storage structure is locked;
in response to determining that the second vertical storage structure is not locked, locking the second vertical storage structure, and controlling the transport robot to move from the first entry-exit point of the first vertical storage structure to the second entry-exit point of the second vertical storage structure;
in response to determining that the second vertical storage structure is locked, controlling the transport robot to move from the first entry-exit point of the first vertical storage structure to the second entry-exit point of the second vertical storage structure.

6. The method as claimed in claim 1, wherein the first vertical storage structure comprises a first entry-exit point at a bottom of the first vertical storage structure, and controlling the first transport robot to move to the current position to transport the first target object to the first target position comprises:
controlling the first transport robot to move, at the bottom of the cube storage structure, to the first entry-exit point, and controlling the first transport robot to vertically ascend, from the first entry-exit point, in the first vertical storage structure to the current position of the first target object for the first transport robot to access the first target object;
controlling the first transport robot to move the first target object from the current position to the first target position.

7. The method as claimed in claim 6, wherein controlling the first transport robot to move the first target object from the current position to the first target position comprises:
controlling the first transport robot to vertically descend from the current position of the first target object to the first entry-exit point of the first vertical storage structure, and controlling the first transport robot to move from the first entry-exit point of the first vertical storage structure to the first target position.

8. The method as claimed in claim 1, wherein the first target position is an outbound point of the cube storage structure.

9. The method as claimed in claim 8, wherein the first transport task corresponds to a sorting task, and the method further comprises:
in response to determining that the first target object is transported to the first target position, determining whether a sorting workstation is available;
in response to determining that the sorting workstation is available, controlling an object-moving robot to move the first target object from the first target position to the sorting workstation.

10. The method as claimed in claim 9, wherein the first target object is an item storage object storing at least one item, and the method further comprises:
after the sorting task is completed, determining whether the first target object in the sorting workstation is empty;
in response to determining that the first target object is not empty, controlling a second transport robot to store the first target object in the cube storage structure through a return process.

11. The method as claimed in claim 10, wherein the return process comprises:
determining that the first target object is in a third object storage space in the cube storage structure, wherein the third object storage space belongs to a third vertical storage structure in the cube storage structure, and there is a third entry-exit point at a bottom of the third vertical storage structure;
controlling the second transport robot to move to an inbound point of the cube storage structure, and controlling the object-moving robot to move the first target object from the sorting workstation to the second transport robot at the inbound point;
controlling the second transport robot to move from the inbound point of the cube storage structure to the third entry-exit point of the third vertical storage structure; and
controlling the second transport robot to vertically ascend in the third vertical storage structure to the third object storage space, and securing the first target object to the third object storage space.

12. The method as claimed in claim 11, wherein before controlling the second transport robot to move from the inbound point of the cube storage structure to the third entry-exit point of the third vertical storage structure, the method further comprises:
determining whether the third vertical storage structure is locked;
in response to determining that the third vertical storage structure is not locked, locking the third vertical storage structure, and controlling the second transport robot to move from the inbound point of the cube storage structure to the third entry-exit point of the third vertical storage structure;
in response to determining that the third vertical storage structure is locked, controlling the second transport robot to move from the inbound point of the cube storage structure to the third entry-exit point of the third vertical storage structure.

13. The method as claimed in claim 11, wherein after securing the first target object to the third object storage space, the method further comprises:
controlling the second transport robot to vertically descend to the third entry-exit point of the third vertical storage structure, and unlocking the third vertical storage structure.

14. The method as claimed in claim 10, further comprising:
in response to determining that the first target object is empty, controlling the object-moving robot to move the first target object to a third transport robot, and controlling the third transport robot to transport the first target object to an empty object station.

15. The method as claimed in claim 9, wherein the first target object is an item storage object storing at least one item, the first transport task corresponds to an inventory task, and the method further comprises:
in response to determining that the at least one item stored in the first target object is correct through inventory, controlling a second transport robot to store the first target object in the cube storage structure through a return process.

16. The method as claimed in claim 1, further comprising:
obtaining a loading task, and associating the loading task with a second target object, wherein the second target object is an item storage object and is initialized to be empty, and the loading task indicates to load at least one item into the second target object;
during the process of loading the at least one item into the second target object, determining whether a weight of the second target object is about to exceed a weight threshold;
in response to determining that the weight of the second target object is not about to exceed the weight threshold, allowing the at least one item to continue being loaded into the second target object;
in response to determining that the weight of the second target object is about to exceed the weight threshold, controlling a second transport robot to store the second target object in the cube storage structure through a return process, and introducing a third target object to support the loading task.

17. A cube storage system, comprising:
a cube storage structure comprising a first vertical storage structure, wherein the first vertical storage structure comprises a plurality of first object storage spaces arranged vertically; and
a control system configured to:
in response to a first transport task for a first target object stored in the first vertical storage structure, determine whether there is a blocking object relative to the first target object stored in the first vertical storage structure, wherein the first transport task indicates to transport the first target object from a current position to a first target position, and the current position of the first target object corresponds to one of the first object storage spaces;
in response to determining that there is the blocking object relative to the first target object stored in the first vertical storage structure, control at least one assisting transport robot to move at a bottom of the cube storage structure to a bottom of the first vertical storage structure, directly climb vertically within a space of the first vertical storage structure from the bottom of the first vertical storage structure to a position below the blocking object, access the blocking object and then vertically descend within the first vertical storage structure to the bottom of the first vertical storage structure to remove the blocking object from the first vertical storage structure;
in response to determining that there is no blocking object relative to the first target object stored in the first vertical storage structure, control a first transport robot to move at the bottom of the cube storage structure to the bottom of the first vertical storage structure, climb vertically within the space of the first vertical storage structure from the bottom of the first vertical storage structure to the current position, access the first target object and then vertically descend within the first vertical storage structure to the bottom of the first vertical storage structure to transport the first target object to the first target position.
